(19) United States
(12) Patent Application Publication
(10) Pub. No.: US 2026/0197612 A1
(43) Pub. Date: Jul. 9, 2026

(54) Methods And Apparatus For Integrated Sensing And Communication Operations In Mobile Communications

(71) Applicant: MediaTek Singapore Pte. Ltd., Singapore (SG)

(72) Inventors: Wenze Qu, Beijing (CN); Haoran Li, Beijing (CN); Xuanbo Shao, Beijing (CN); Min Lei, Beijing (CN); Tao Chen, Beijing (CN)

(73) Assignee: MediaTek Singapore Pte. Ltd., Singapore (SG)

(21) Appl. No.: 19/435,746

(22) Filed: Dec. 30, 2025

(30) Foreign Application Priority Data
Jan. 3, 2025 (WO) PCT/CN2025/070389
Jan. 3, 2025 (WO) PCT/CN2025/070424
Jan. 3, 2025 (WO) PCT/CN2025/070426
Mar. 13, 2025 (WO) PCT/CN2025/082449
Dec. 8, 2025 (CN) 202511843818.4

(51) Int. Cl. H04W 4/38; H04W 68/02; H04W 72/231

(52) U.S. Cl. CPC H04W 4/38; H04W 68/02; H04W 72/231

(57) ABSTRACT

Various solutions for integrated sensing and communication (ISAC) operations with respect to an apparatus in mobile communications are described. The apparatus may determine a sensing report including at least one sensing report unit. Each sensing report unit may correspond to at least part of a target. The apparatus may transmit the sensing report to a network node.

### CROSS REFERENCE TO RELATED PATENT APPLICATION(S)

The present disclosure is part of a non-provisional application claiming the priority benefit of PCT Application No. PCT/CN2025/070389, filed on 3 Jan. 2025, PCT Application No. PCT/CN2025/070424, filed on 3 Jan. 2025, PCT Application No. PCT/CN2025/070426, filed on 3 Jan. 2025, PCT Application No. PCT/CN2025/082449, filed 13 Mar. 2025, and CN application Ser. No. 20/2511843818.4, filed on 8 Dec. 2025, the contents of which herein being incorporated by reference in their entirety.

### TECHNICAL FIELD

The present disclosure is generally related to mobile communications and, more particularly, to integrated sensing and communication (ISAC) operations with respect to apparatus in mobile communications.

### BACKGROUND

Unless otherwise indicated herein, approaches described in this section are not prior art to the claims listed below and are not admitted as prior art by inclusion in this section.

In New Radio (NR) mobile communications, Integrated Sensing and Communication (ISAC) systems have been developed. In particular, ISAC systems may enable simultaneous environmental sensing and wireless communication by reusing shared waveform resources (e.g., Orthogonal Frequency-Division Multiplexing (OFDM) signals).

Although various sensing procedures have been proposed for ISAC systems, existing techniques generally do not address how sensing nodes may correctly report sensing data corresponding to different targets or different sensing paths. Specifically, mechanisms for distinguishing multiple targets, associating sensing measurements with the appropriate target or path, and reporting such information in a structured and unambiguous manner remain insufficiently discussed in conventional approaches.

Furthermore, when multiple sensing resources, beams, or configurations are applied across different sensing stages, existing approaches generally do not provide adequate mechanisms for enabling a sensing node to understand how a newly configured sensing resource may be associated with previously obtained sensing data. Without a clear indication of the relationship between configured sensing resources and earlier sensing results, the sensing node may be unable to effectively utilize stored information corresponding to different targets or sensing paths, which may in turn impact the continuity and reliability of subsequent sensing operations.

In addition, how sensing signals may be utilized in various ways to enhance overall network efficiency may be further considered in ISAC systems. Although sensing signals have been introduced for environmental perception, conventional studies generally do not provide detailed mechanisms for coordinating or managing such sensing signals across different sensing procedures, nor do they address how the use of sensing signals may interact with or influence ongoing communication operations. Consequently, the organization, scheduling, and utilization of sensing signals to achieve improved system performance remain insufficiently addressed in existing techniques.

Accordingly, addressing the above issues and improving the overall efficiency of ISAC systems has become an important consideration in newly developed wireless communication networks.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to integrated sensing and communication (ISAC) operations with respect to apparatus in mobile communications.

In one aspect, a method may involve an apparatus determining a sensing report including at least one sensing report unit. Each sensing report unit may correspond to at least part of a target. The method may further involve the apparatus transmitting the sensing report to a network node.

In one aspect, an apparatus may comprise a transceiver which, during operation, wirelessly communicates with a wireless network. The apparatus may also comprise a processor communicatively coupled to the transceiver. The processor, during operation, may perform operations comprising determining a sensing report including at least one sensing report unit. Each sensing report unit may correspond to at least part of a target. The processor may further perform operations comprising transmitting, via the transceiver, the sensing report to a network node.

In one aspect, a method may involve an apparatus determining a sensing configuration including at least one of a sensing report unit identification, a cell identification, a resource set, and a resource. The method may further involve the apparatus transmitting the sensing configuration to a sensing apparatus.

In one aspect, an apparatus may comprise a transceiver which, during operation, wirelessly communicates with a wireless network. The apparatus may also comprise a processor communicatively coupled to the transceiver. The processor, during operation, may perform operations comprising determining a sensing configuration including at least one of a sensing report unit identification, a cell identification, a resource set, and a resource. The processor may further perform operations comprising transmitting, via the transceiver, the sensing configuration to a sensing apparatus.

In one aspect, a method may involve an apparatus receiving a first stage hybrid sensing signal. The first stage hybrid sensing signal may include at least one of a first sensing signal and a second sensing signal. The method may further involve the apparatus determining a first stage sensing result based on the first stage hybrid sensing signal. The method may further involve the apparatus receiving a second stage hybrid sensing signal. The second stage hybrid sensing signal may include at least one of the first sensing signal and the second sensing signal. The method may further involve the apparatus determining a second stage sensing result based on the second stage hybrid sensing signal.

In one aspect, an apparatus may comprise a transceiver which, during operation, wirelessly communicates with a wireless network. The apparatus may also comprise a processor communicatively coupled to the transceiver. The processor, during operation, may perform operations comprising receiving, via the transceiver, a first stage hybrid sensing signal. The first stage hybrid sensing signal may include at least one of a first sensing signal and a second sensing signal. The processor may further perform operations comprising determining a first stage sensing result based on the first stage hybrid sensing signal. The processor may further perform operations comprising receiving, via the transceiver, a second stage hybrid sensing signal. The second stage hybrid sensing signal may include at least one of the first sensing signal and the second sensing signal. The processor may further perform operations comprising determining a second stage sensing result based on the second stage hybrid sensing signal.

In one aspect, a method may involve an apparatus transmitting a first stage hybrid sensing signal for determining a first stage sensing result. The first stage hybrid sensing signal may include at least one of a first sensing signal and a second sensing signal. The method may further involve the apparatus transmitting, by the processor, a second stage hybrid sensing signal for determining a second stage sensing result. The second stage hybrid sensing signal may include at least one of the first sensing signal and the second sensing signal.

In one aspect, an apparatus may comprise a transceiver which, during operation, wirelessly communicates with a wireless network. The apparatus may also comprise a processor communicatively coupled to the transceiver. The processor, during operation, may perform operations comprising transmitting, via the transceiver, a first stage hybrid sensing signal for determining a first stage sensing result. The first stage hybrid sensing signal may include at least one of a first sensing signal and a second sensing signal. The processor may further perform operations comprising transmitting, via the transceiver, a second stage hybrid sensing signal for determining a second stage sensing result. The second stage hybrid sensing signal may include at least one of the first sensing signal and the second sensing signal.

In one aspect, a method may involve an apparatus receiving an indication from a network node indicating use of sensing signals to facilitate a communication operation. The method may further involve the apparatus performing the communication operation based on the indication.

In one aspect, an apparatus may comprise a transceiver which, during operation, wirelessly communicates with a wireless network. The apparatus may also comprise a processor communicatively coupled to the transceiver. The processor, during operation, may perform operations comprising receiving, via the transceiver, an indication from a network node indicating use of sensing signals to facilitate a communication operation. The processor may further perform operations comprising performing the communication operation based on the indication.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a diagram depicting an example scenario under schemes in accordance with implementations of the present disclosure.

FIG. 6 is a diagram depicting an example scenario under schemes in accordance with implementations of the present disclosure.

FIG. 7 is a diagram depicting an example scenario under schemes in accordance with implementations of the present disclosure.

FIG. 8 is a diagram depicting an example scenario under schemes in accordance with implementations of the present disclosure.

FIG. 9 is a diagram depicting an example scenario under schemes in accordance with implementations of the present disclosure.

FIG. 10 is a diagram depicting an example scenario under schemes in accordance with implementations of the present disclosure.

FIG. 11 is a diagram depicting an example scenario under schemes in accordance with implementations of the present disclosure.

FIG. 12 is a diagram depicting an example scenario under schemes in accordance with implementations of the present disclosure.

FIG. 13 is a diagram depicting an example scenario under schemes in accordance with implementations of the present disclosure.

FIG. 14 is a diagram depicting an example scenario under schemes in accordance with implementations of the present disclosure.

FIG. 15 is a diagram depicting an example scenario under schemes in accordance with implementations of the present disclosure.

FIG. 16 is a block diagram of an example communication system in accordance with an implementation of the present disclosure.

FIG. 17 is a flowchart of an example process in accordance with an implementation of the present disclosure.

FIG. 18 is a flowchart of an example process in accordance with an implementation of the present disclosure.

FIG. 19 is a flowchart of an example process in accordance with an implementation of the present disclosure.

FIG. 20 is a flowchart of an example process in accordance with an implementation of the present disclosure.

FIG. 21 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to integrated sensing and communication (ISAC) operations with respect to apparatus in mobile communications. According to the present disclosure, a number of possible solutions may be implemented separately or jointly. That is, although these possible solutions may be described below separately, two or more of these possible solutions may be implemented in one combination or another.

First, it should be noted that, in an Integrated Sensing And Communication (ISAC) system, there may be one or more sensing apparatus. The sensing apparatus may include a transmitter (TX) and a receiver (RX). In some scenarios, the TX and RX may be either co-located or spatially separated. When the TX and RX are co-located, for example, within a common sensing apparatus, the system may be referred to as a monostatic sensing system. When the TX and RX are disposed at different locations, for example, within different sensing apparatus, the system may be referred to as a bistatic sensing system. It should be noted that the following disclosed techniques may be applied to either a monostatic sensing system or a bistatic sensing system.

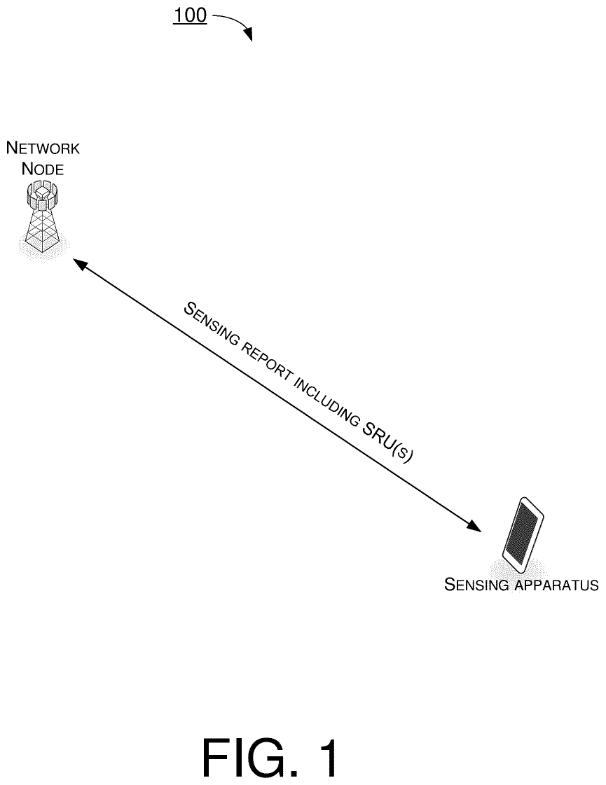

FIG. 1 illustrates an example scenario 100 under schemes in accordance with implementations of the present disclosure. In some embodiments, a sensing apparatus (e.g., an RX including a User Equipment (UE) or a Base Station (BS)) may determine a sensing report after sensing procedures. The sensing report may include at least one Sensing Report Unit SRU). Each SRU may correspond to at least part of a target (i.e., sensing target). In particular, each SRU may be a basic reporting unit which may correspond to: (1) one target, or (2) part (e.g., path(s)) of one target. Each SRU may include quantities of multiple domains. Then, the sensing apparatus may transmit the sensing report to a network node (e.g., BS having sensing function or Core network (CN) having sensing function). It should be noted that in FIG. 1, the sensing apparatus (i.e., ISAC node) is depicted as a UE for illustration purposes only and is not intended to limit the functionality or role of the sensing apparatus.

In some implementations, each SRU may be associated with a size information of a grid. Each SRU may include at least one of: (1) a target identification, (2) a delay information, (3) a Doppler information, (4) an angle information, (5) a resource identification information, and (6) a power information.

In some implementations, each SRU may be associated with: (1) absolute values, or (2) relative values corresponding to a reference SRU. In particular, in some cases, each parameter of an SRU may be represented as an absolute value. In some cases, each parameter of an SRU may be represented as a relative value with respect to a reference SRU. In other words, other SRUs may carry parameter differences relative to the reference SRU for each corresponding quantity.

In some implementations, each SRU may be associated with an SRU identification. In some cases, the SRU identification of a corresponding SRU may be implicitly determined based on the order in which the SRUs are reported. In some cases, the SRU identification may be explicitly indicated using an integer.

For example, a format of one SRU is expressed as: SRU #n: {target identification, delay information, Doppler information, angle information, resource identification information, power information}, where n is the SRU identification.

In some cases, the SRU identification may include (1) a void value or (2) a real value. The value may be represented as an integer. When the SRU identification includes a void value, it may indicate that the SRU identification is implicitly determined based on the order of the reported SRU(s). When the SRU identification includes a real value, it may indicate that the SRU identification is explicitly expressed by an integer.

In other words, the SRU identification may be used to differentiate SRUs so that a network node (having sensing function) and a sensing node may respectively control subsequent sensing operations for different SRUs (or targets), including sensing resource allocation, receiving-side (RX-side) signal reception, and signal processing.

In some cases, the size information of the grid may be associated with delay information (in seconds), Doppler information (in hertz), and angle information (in radians).

In some cases, the delay information may include at least one of: (1) a timing difference of arrival (TDOA), (2) a receiving-transmitting (RX-TX) timing (RTT) difference, and (3) a timing of arrival (ToA). Unit of the delay information may include a number of grids of delay information.

In some cases, the Doppler information may include at least one of: (1) a Doppler parameter, (2) a phase variation parameter, and (3) a speed parameter. Unit of the Doppler information may include a number of grids of Doppler information.

In some cases, the angle information may include at least one of: (1) an Angle of Arrival (AoA), (2) a Zenith Angle of Arrival (ZoA), (3) an Angle of Departure (AoD), (4) a Zenith Angle of Departure (ZoD), and (5) a TX beam index. Unit of the angle information may be a number of grids of AoA, ZoA, AoD, and/or ZoD.

In some cases, the resource identification information may include at least one of: (1) a timestamp of resource, (2) a cell identification, and (3) a resource set and resource identification. The purpose of the resource identification information may be to indicate the resource corresponding to the reported SRU, including a timestamp of the resource, an indication of the serving or neighboring cell, a resource-set identifier, and a resource identifier that may indicate a TX beam.

In some cases, the power information may include at least one of: (1) an average power of SRU, (2) a size of SRU, (3) a total power of SRU, (4) an average power of interference and noise, and (5) a Signal to Interference and Noise Ratio (SINR). Unit of power may include dBm. The average power of SRU may represent power within one grid. Unit of size of SRU may include the number of grids of all information (e.g., delay information, Doppler information, and angle information).

In some cases, the power information may be considered as two parts including a power part and a degree of confidence part. In particular, the power part may include at least one of: (1) the average power of SRU, (2) the size of SRU, (3) the total power of SRU, and (4) the SINR. The SINR may be used in place of the average power of the SRU. The degree of confidence part may include at least one of: (1) the average power of interference and noise and (2) the SINR. The SINR (in dB) may be obtained by subtracting an interference-and-noise power level (in dB) from an average SRU power level (in dB), corresponding to a ratio between the average power of interference and noise and the average power of SRU in the linear domain.

In some implementations, the SRUs may be differentiated based on their corresponding sensing data. In particular, when the sensing data can be distinguished according to quantities in some domains, the sensing data may be reported as an independent SRU. More specifically, the domains may include delay, Doppler, angle, and resource (i.e., cell identification, resource set, resource identification).

In some cases, the SRUs may correspond to different targets or multiple parts of the same target. In some cases, the SRUs may correspond to different measurement results of the same target using different sensing resources (e.g., from different base stations or different transmitter (TX) beams). In some cases, the number of SRUs may be equal to a product of the number of targets, the number of parts of each target, the number of TX nodes, and the number of TX beams of each TX node.

In some implementations, the grid may include at least one granularity associated with at least one of the delay domain, Doppler domain, and angle domain. In particular, the grid may be defined as the granularity of sensing report data including delay information, Doppler information, angle information (i.e., AoD, ZoD, AoA, ZoA), etc.

In some cases, the grid may be associated with one dimension or multiple dimensions according to the sensing reporting data. For example, the grid is associated with one dimension, which is the delay domain. The grid is associated with two dimensions, which are the delay domain and the Doppler domain. The grid is associated with six dimensions, which are the delay domain, Doppler domain, AoD, ZOD, AoA, and ZoA.

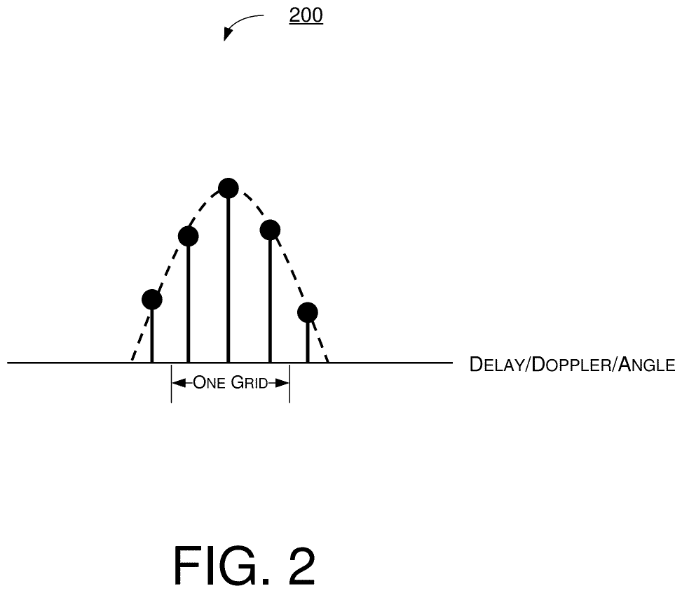

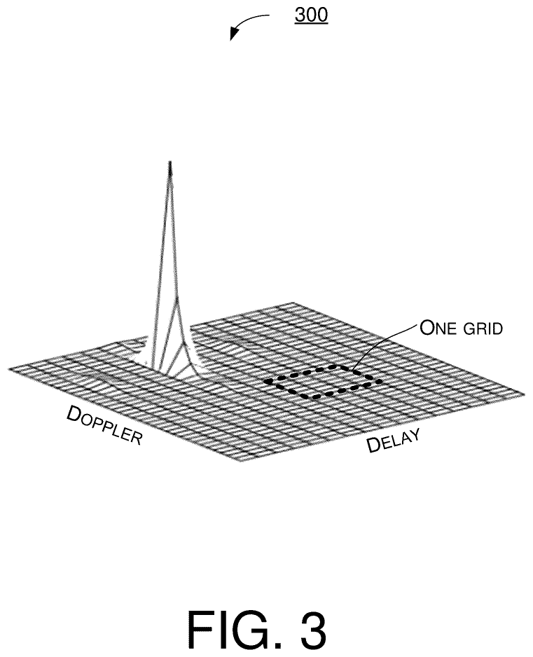

FIG. 2 illustrates an example scenario 200 under schemes in accordance with implementations of the present disclosure. For example, the grid is associated with one dimension (e.g., delay, Doppler, or angle). FIG. 3 illustrates an example scenario 300 under schemes in accordance with implementations of the present disclosure. For example, the grid (as shown as a thick dotted line) is associated with two dimensions which are delay and Doppler.

In some implementations, the size information of the grid may be the size of grid in each domain. The size of grid may be separately defined for each domain of sensing report data. For example, the size of grid for [delay, Doppler, AoD, ZOD, AoA, ZoA] is [s1 (meter), s2 (meter/second), s3 (radians), s4 (radians), s5 (radians), s6 (radians)]. It should be note that the size of the grid may be expressed in the original domain units second for delay, hertz for Doppler, radians for AoD/ZoD/AoA/ZoA, while the corresponding physical quantities may be represented as s1 (meter), s2 (meter/second), s3 (radians), s4 (radians), s5 (radians), s6 (radians), respectively.

In some cases, no predetermined relationship may be required between the size of the grid and a sensing resolution achievable by the sensing TX, sensing RX, or the sensing signal. Accordingly, the size of the grid may be larger than, smaller than, or equal to the sensing resolution. For example, the sensing resolution may exceed the grid size.

In some cases, the size of the grid may be determined by the sensing apparatus (e.g., RX) itself and reported to the network node (having sensing function) along with the sensing data.

In some cases, a default value may be used as the size of the grid. In particular, the default value may be set based on the sensing resolution of usual TX/RX configurations (e.g., antenna aperture) and sensing signal configurations (e.g., Bandwidth (BW), Coherent Procession Interval (CPI)).

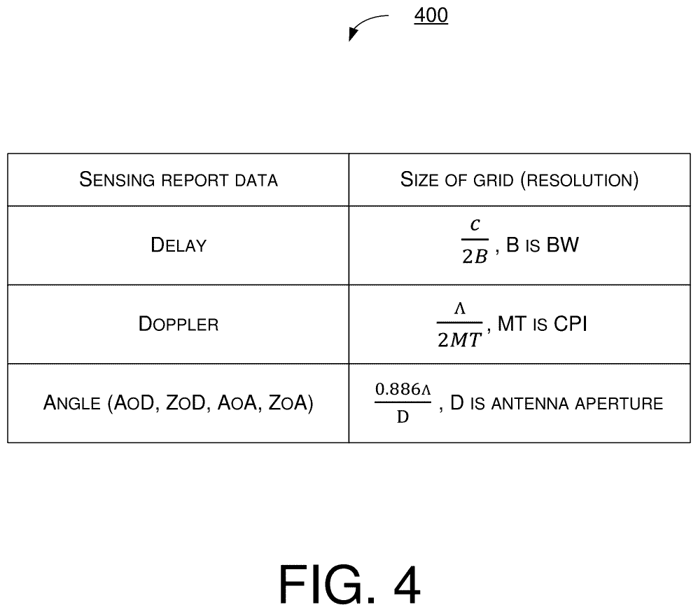

FIG. 4 illustrates an example scenario 400 under schemes in accordance with implementations of the present disclosure. For example, the size of grid (resolution) for delay sensing report data is

$$\frac{c}{2 B} ,$$

where B is BW and c is the speed of light. The size of grid (resolution) for Doppler sensing report data is

$$\frac{λ}{2 M T} ,$$

where λ is the wavelength and MT is the CPI. The size of grid (resolution) for angle sensing report data is

$$\frac{0.886 λ}{D} ,$$

where D is the antenna aperture.

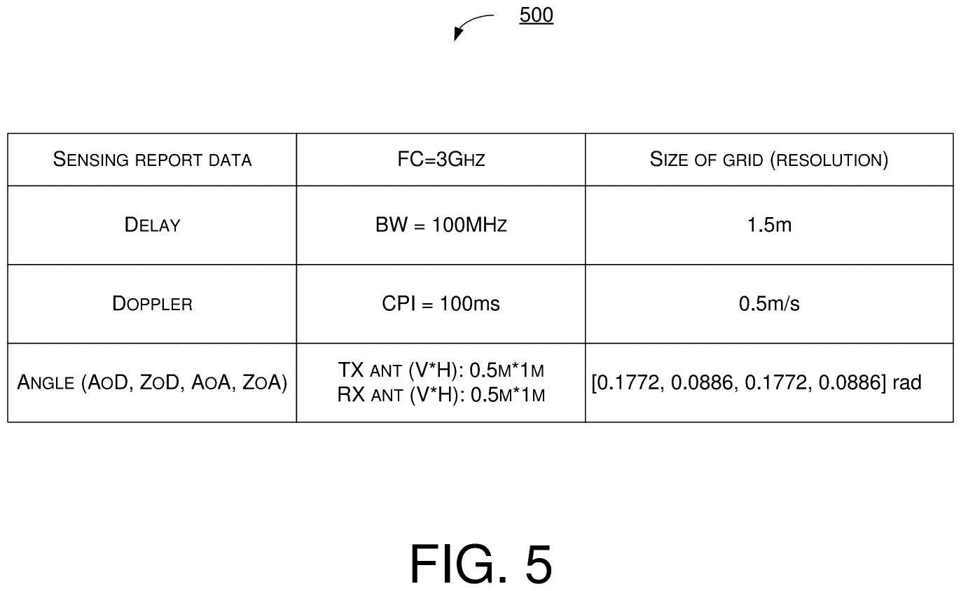

FIG. 5 illustrates an example scenario 500 under schemes in accordance with implementations of the present disclosure. For example, the frequency is 3 GHz. BW is 100 MHz. The TX antenna (TX ant) has dimensions of 0.5 m in the vertical direction and 1.0 m in the horizontal direction. The RX antenna (RX ant) has dimensions of 0.5 m in the vertical direction and 1.0 m in the horizontal direction. CPI is 100 milliseconds. The size of grid (resolution) for delay sensing report data is 1.5 m. The size of grid (resolution) for Doppler sensing report data is 0.5 m/s. The size of grid (resolution) for angle sensing report data is [0.1772, 0.0886, 0.1772, 0.0886] (unit in radians).

In some cases, the size of the grid may be directly configured by the network node (having a sensing function). In some cases, the size of the grid may be computed from one or more configured parameters, such as BW, CPI, and TX/RX antenna aperture.

In some cases, the size of the grid may be computed based on the configurations of the currently used TX/RX antenna and sensing signal.

In some implementations, the reporting quantities of delay, Doppler, and angle information may be determined based on the granularity. In particular, the measurement result of each domain may be quantized with the size of the grid as the granularity. When necessary, the quantized result may be reported to the network node (having a sensing function).

In some cases, the quantized result may be obtained by quantizing each measurement result using the corresponding size of the grid as the quantization granularity. For each domain, the measurement result may be divided by the size of the grid, and the quotient may be rounded to the nearest integer. For example, when the measurement result of delay, doppler, AoD, ZOD, AoA, ZoA corresponds to [3.1 m, 1.2 m/s, 0.2, 0.2, 0.3, 0.4] and the size of the grid corresponds to [1.5 m, 0.5 m/s, 0.1772, 0.0886, 0.1772, 0.0886], the reporting data is quantized as [2, 2, 1, 2, 2, 5].

In some implementations, the power information may be reported based on the SRU. In particular, a total power of the SRU may be equal to a product of an average power of the SRU and a size of the SRU.

In some cases, the average power may be defined on a per-grid-unit basis. Because the grid may include one or multiple dimensions, the average power may correspond to an average value over all relevant dimensions.

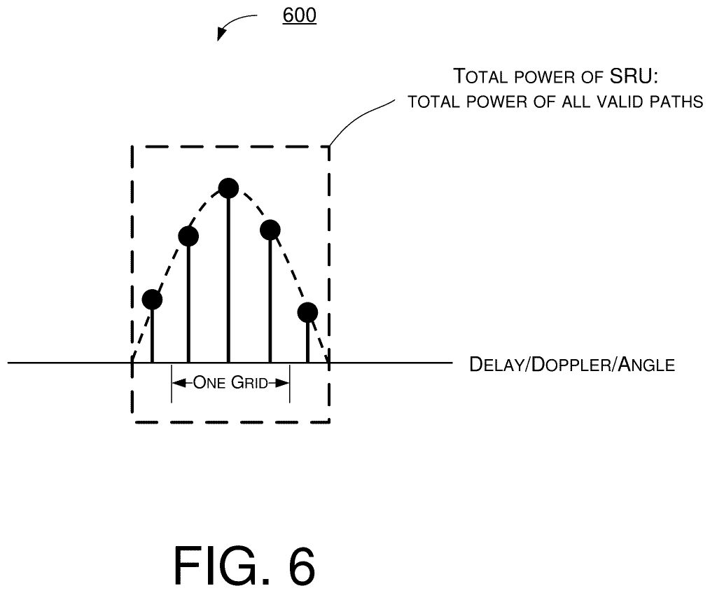

FIG. 6 illustrates an example scenario 600 under schemes in accordance with implementations of the present disclosure. For example, the total power of the SRU corresponds to the total power of all valid paths, which are enclosed by a dotted frame.

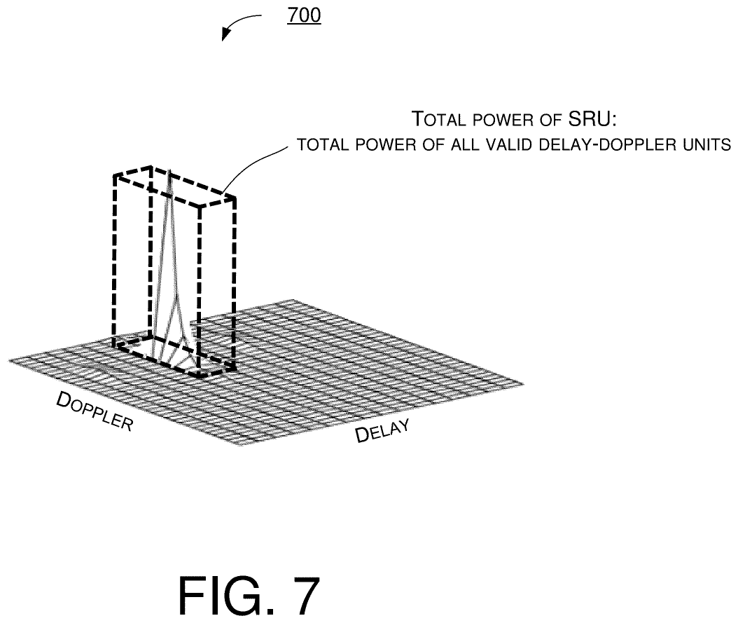

FIG. 7 illustrates an example scenario 700 under schemes in accordance with implementations of the present disclosure. For example, the total power of the SRU corresponds to the total power of all valid delay-Doppler units, which are enclosed by a dotted cube.

In some cases, the size of SRU may be defined as the number of grids. When the grid includes multiple dimensions, the size of SRU may be a product of the size of each dimension. The size of SRU may be used to express the size of one target or the size of a part of one target. The size of the SRU may be a decimal value (e.g., smaller than one) when the sensing resolution is smaller than the grid size.

In some cases, the sensing apparatus (e.g., RX) may report: (1) the total power of SRU, or (2) the average power of SRU and the size of SRU separately to the network node (having sensing function).

For example, the grid includes one dimension corresponding to the delay domain. The size of the grid is 1.5 m, the size of SRU is 2, the average power of SRU is −90 dBm, and the total power of SRU is −87 dBm. For another example, the grid includes two dimensions corresponding to the delay domain and the Doppler domain. The size of the grid is [1.5 m, 0.5 m/s], the size of SRU is 2, the average power of SRU is −90 dB, and the total power of SRU is −87 dBm.

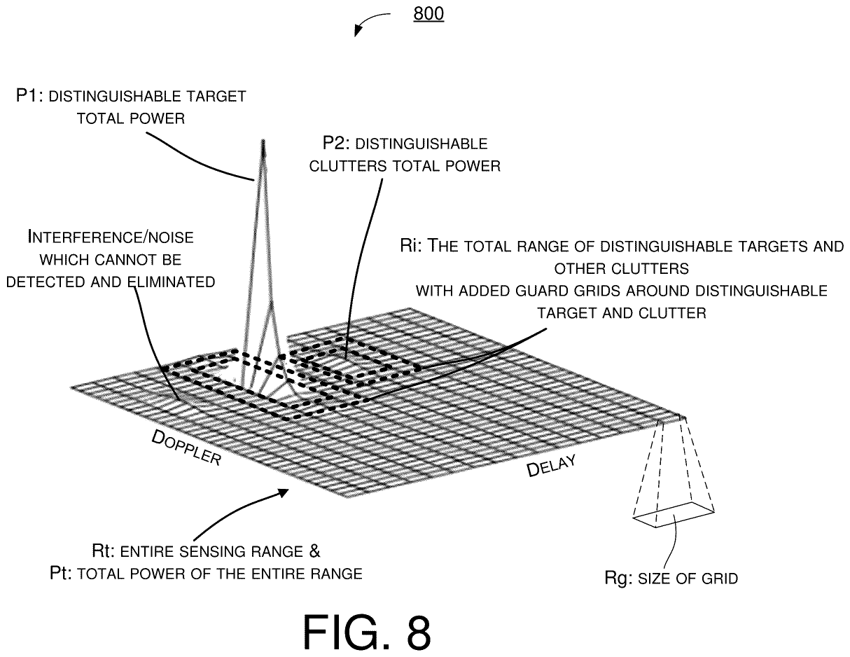

FIG. 8 illustrates an example scenario 800 under schemes in accordance with implementations of the present disclosure. In some implementations, an average power of interference and noise may be determined. In particular, an entire sensing range may be denoted as Rt (unit: number of grids). A total power of the entire sensing range may be denoted as Pt. A total range of distinguishable (or detectable) targets and other clutters may be denoted as Rᵢ (unit: number of grids), as shown by the outer dotted frames of the areas. A total power of distinguishable (or detectable) targets may be denoted as P1. A total power of other clutters (or detectable) may be denoted as P2. A size of the grid may be denoted as Rg.

Accordingly, a total power of interference and noise (including targets, clutter and noise which may not be detected and eliminated) may be denoted as Pn where Pn=Pt−P1−P2. An average power of interference and noise may be computed as Pn/(Rt−Ri)×Rg.

In some cases, the entire sensing range Rt may correspond to the maximum sensing range in the delay, Doppler, and angle domains that may be achieved by the sensing signal (i.e., a maximum unambiguous range). The entire sensing range Rt may also be determined based on the requirements of a sensing task, such as a range of interest for the sensing task or a region in which a sensing target is expected to be detected.

In some cases, distinguishable (or detectable) targets and clutters may include all targets and/or clutters (whether stationary or moving) that may be detected by the sensing apparatus (e.g., RX) using a given sensing algorithm. The targets may include objects intended to be detected or tracked by a sensing service, such as Unmanned Aerial Vehicles (UAVs), vehicles, or pedestrians. The clutters may include environmental objects, such as buildings, walls, vegetation, or the ground. In bi-static sensing scenarios, a Line-of-Sight (LoS) path between a TX and an RX may also be treated as a distinguishable clutter. In mono-static sensing scenarios, self-interference may be regarded as a distinguishable clutter as well.

In some cases, the purpose of multiplying by R_{g} may be to obtain the average interference-and-noise power contained within a single grid. In other words, an average granularity may correspond to one grid. The granularity may also be extended to other values.

In some cases, the average power of interference and noise (i.e., value of Pn/(Rt−Ri)×Rg) may be considered as being contained in one grid, and the unit may be dBm.

In some cases, additional operations may be performed when calculating P₁ and P₂. In particular, guard grids (i.e., grids between the outer dotted line and the inner dotted line) may be added around distinguishable targets, and P₁ may represent the total power of the targets together with the power of the surrounding guard grids. A similar approach may be applied to distinguishable clutters for the calculation of P₂. The purpose of adding such guard grids may be to prevent sidelobes around distinguishable targets or clutters from being treated as interference and noise that may not be detected or removed, which may otherwise affect the accuracy of Pn.

In some cases, the SINR (in dB) of SRU may be obtained by subtracting the average power (in dBm) of interference and noise from the average power (in dBm) of SRU, corresponding to the ratio of the two powers in the linear domain. The sensing apparatus (e.g., RX) may report the average power of interference and noise directly or the SINR.

In some implementations, the network node may include a Radio Access Network (RAN) node having a sensing function and/or a CN having a sensing function. In particular, sensing data reporting and processing may be subject to low-latency requirements (e.g., for low-latency sensing tasks or sensing-assisted communication operations). A large amount of sensing data may need to be reported. The RAN node may require access to the sensing data, at least in some cases, such as (1) sensing data integration for BS mono-static sensing and BS-UE bi-static sensing (downlink) performed at the BS, and (2) sensing use cases or scenarios requiring low latency. Since different network architectures may be adopted (i.e., placing the sensing function in the CN or in the RAN node), corresponding reporting mechanisms may be applied depending on the selected architecture.

In some cases, the sensing function may be on the RAN node (e.g., BS). The sensing apparatus (e.g., a UE or a BS) may report sensing data to the RAN node having sensing function by using a Radio Resource Control (RRC) message, a Media Access Control Control Element (MAC CE), and/or a layer-1 (L1) message. Accordingly, the RAN node may obtain the sensing data. In addition, a large amount of sensing data may be segmented into multiple smaller packages (e.g., one message per SRU). The RRC message may support such segmented reporting.

In some cases, the sensing function may be on the CN. The sensing apparatus (e.g., a UE or a BS) may report sensing data to the CN through the data plane. The RAN node may not obtain the sensing data.

In some cases, the sensing function may be on both the RAN node and the CN. The sensing apparatus (e.g., a UE or a BS) may report part of the sensing data to the RAN node and part of the sensing data to the CN. The part of sensing data reported to the RAN node may include at least of: (1) the SRU identification, (2) the resource identification information (e.g., cell identification, resource set/resource identification (TX beam)), and (3) the power information. The part of sensing data may be reported to the RAN through the L1 message and/or the MAC CE. The purpose of such reporting may be to enable the RAN node to rapidly adjust sensing-resource configurations, such as by adapting TX beams for target tracking or by adjusting power levels and time and frequency domain configurations (e.g., sensing link adaptation) based on sensing quality.

In some cases, all the sensing data may be reported to the RAN node, and then the RAN node may report all the sensing data to the CN.

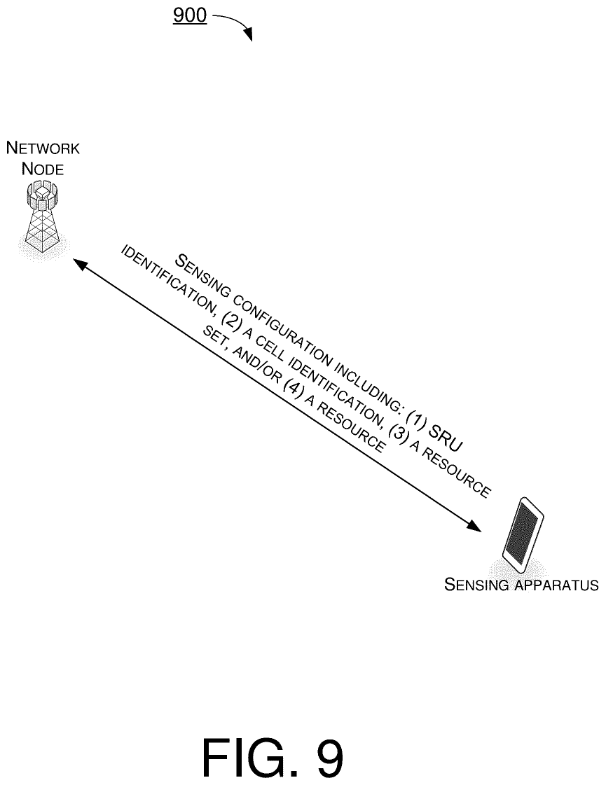

FIG. 9 illustrates an example scenario 900 under schemes in accordance with implementations of the present disclosure. In some embodiments, the network node may determine a sensing configuration. The sensing configuration may include at least one of: (1) an SRU identification, (2) a cell identification, (3) a resource set, and (4) a resource. The network node may transmit the sensing configuration to the sensing apparatus (e.g., UE or BS) for performing sensing operations.

In some implementations, the sensing apparatus may determine a sensing report based on the sensing configuration. In particular, the sensing apparatus may perform sensing operations to determine (e.g., generate) the sensing report based on the sensing configuration. After determining the sensing report, the sensing apparatus may transmit the sensing report to the network node. The network node may receive the sensing report from the sensing apparatus.

In some implementations, the SRU identification may correspond to an SRU number in the latest sensing data reported within a first timing (T1) to a second timing (T2) before the current sensing configuration is received.

In some cases, the SRU identification may be optional. For example, when no target has been detected, the SRU identification may not be configured during the target-detection stage. The SRU identification may instead be configured during a subsequent target-tracking stage.

In some cases, the SRU identification may be the same as a previously reported SRU identification. In some cases, the SRU identification may be mapped to the previously reported SRU identification with a pre-defined rule.

In some cases, the purpose of the SRU identification may be to inform the sensing apparatus of which SRU (or target) a configured resource is primarily intended to measure, thereby enabling the sensing apparatus to perform corresponding processing.

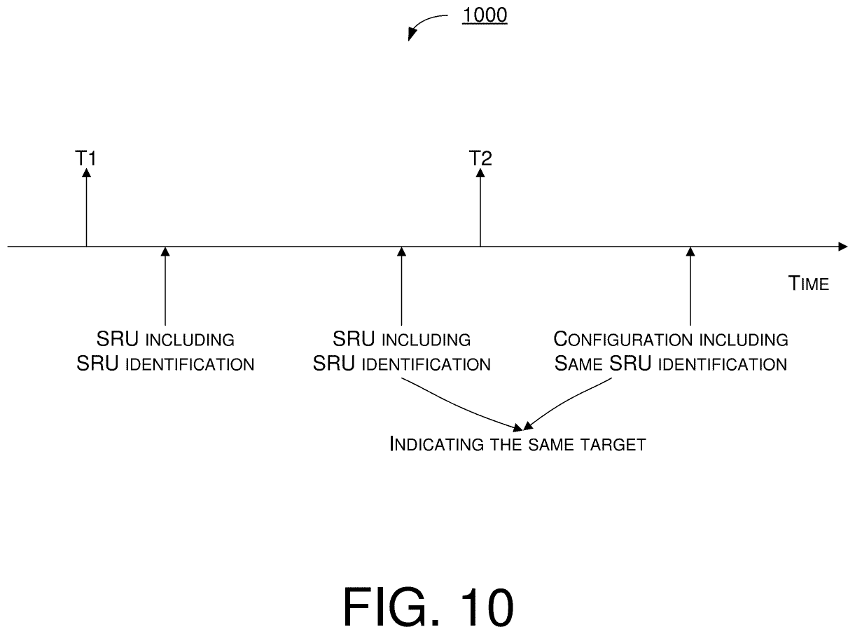

FIG. 10 illustrates an example scenario 1000 under schemes in accordance with implementations of the present disclosure. For example, SRUs have been reported between timings T1 and T2, and each SRU may include an SRU identification. The sensing configuration including the same SRU identification is then transmitted to indicate that the corresponding SRU pertains to the same target for subsequent sensing operations.

In some implementations, the cell identification, the resource set and the resource may refer to configurations of positioning. In particular, sensing signal(s) may be transmitted from a serving cell and/or neighboring cells. For each cell, multiple resource sets and resources may be configured to support sensing using multiple sensing signals (e.g., Positioning Reference Signal (PRS) and Phase Tracking Reference Signal (PTRS)) and multiple TX beams (e.g., Tracking Reference Signal (TRS) with multiple TX beams).

In some implementations, the network node may transmit the sensing configuration and validation information of the sensing signal to the sensing apparatus via a control signaling. In some cases, the control signaling may include a System Information Block (SIB), an RRC, a MAC CE, a Downlink Control Information (DCI), a paging, or a Paging Early Indication (PEI).

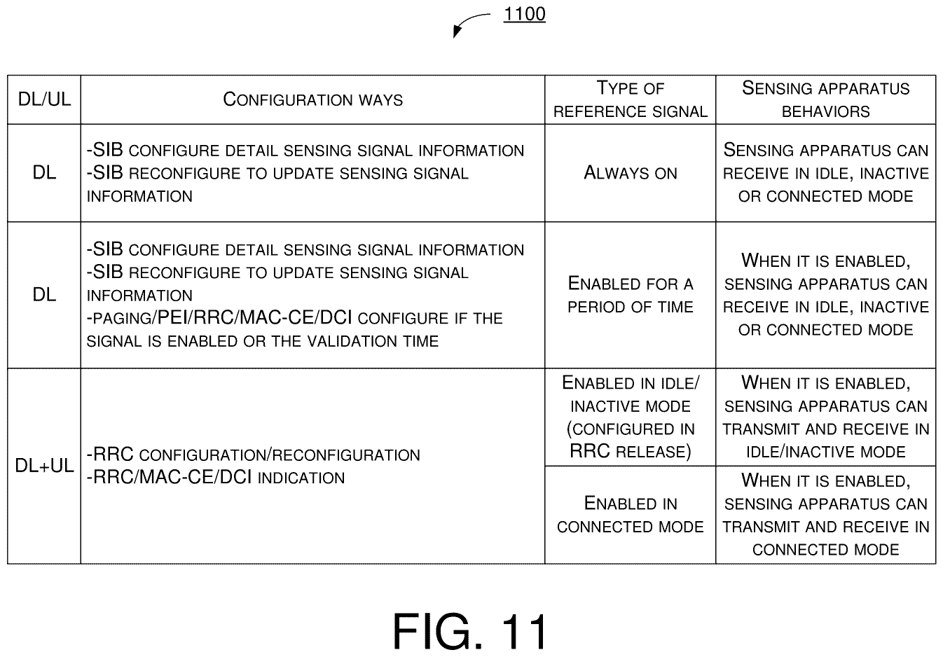

FIG. 11 illustrates an example scenario 1100 under schemes in accordance with implementations of the present disclosure. For example, the details of the control signaling, including an SIB, an RRC, a MAC CE, a DCI, a paging, or a PEI, are illustrated in the table. The configuration(s) is transceived by DL and/or UL message(s).

In one scenario using DL message, the configuration is provided through: (1) a SIB configuring the detailed sensing signal information, or (2) a SIB reconfiguring to update the sensing signal information. The type of reference signal is “Always On”. The sensing apparatus can receive the configuration in idle, inactive, or connected mode.

In one scenario using DL message, the configuration may be provided through: (1) a SIB configuring detail sensing signal information, (2) a SIB reconfiguring to update sensing signal information, or (3) paging, PEI, RRC, MAC CE, or DCI configuring the sensing signal when the signal is enabled or when a validation time is indicated. The type of reference signal is “Enabled for a period of time”. When being enabled, the sensing apparatus can receive the configuration in idle, inactive, or connected mode.

In one scenario using DL and UL messages, the configuration may be provided through: (1) an RCC configuration or RRC reconfiguration, or (2) RRC, MAC CE, or DCI indication. The type of reference signal is “Enabled in idle or inactive mode (configured in RRC release)” or “Enabled in connected mode”. When the type of reference signal is “Enabled in idle or inactive mode (configured in RRC release)”, the sensing apparatus can transmit and receive the configuration in idle or inactive mode. When the type of reference signal is “Enabled in connected mode”, the sensing apparatus can transmit and receive the configuration in connected mode.

It should be noted that the purpose of the SRU identification is to inform the sensing apparatus of which SRU (or target) a configured resource is primarily intended to measure, such that the sensing apparatus may perform corresponding processing.

For example, the sensing apparatus detects multiple targets during a target-detection stage and reports the corresponding SRU identifications to the network node (having sensing function). These targets are detected using different receive beams at the sensing apparatus, and the sensing apparatus locally stores such information. When the sensing apparatus subsequently needs to track one or more of the detected targets, a new sensing resource (e.g., a resource having directional and finer transmit beams) may be configured, together with a QCL relationship relative to the resource used in the detection stage. However, the QCL relationship alone may be insufficient for the sensing apparatus to determine which receive beams should be used. By using the configured SRU identification, the UE determines the appropriate receive beams for sensing-signal reception and processing associated with each SRU.

For another example, sensing data and results obtained during the target-detection stage serve as initial values or assisting information for the subsequent target-tracking stage. This improves tracking performance and may accelerate or simplify the associated processing. Because such data and results differ across targets, the configured SRU identification enables the UE to determine which target-specific data should be used during the tracking stage.

Further, when a target requires continuous tracking, the transmit-beam direction of the sensing resource needs to be adjusted as the target location changes. When such sensing resources are reconfigured, the SRU identification is also configured to indicate which target the updated resource is associated with, thereby preventing the UE from using the resource for detecting new targets. In this manner, the UE utilizes locally stored target information to assist subsequent sensing operations.

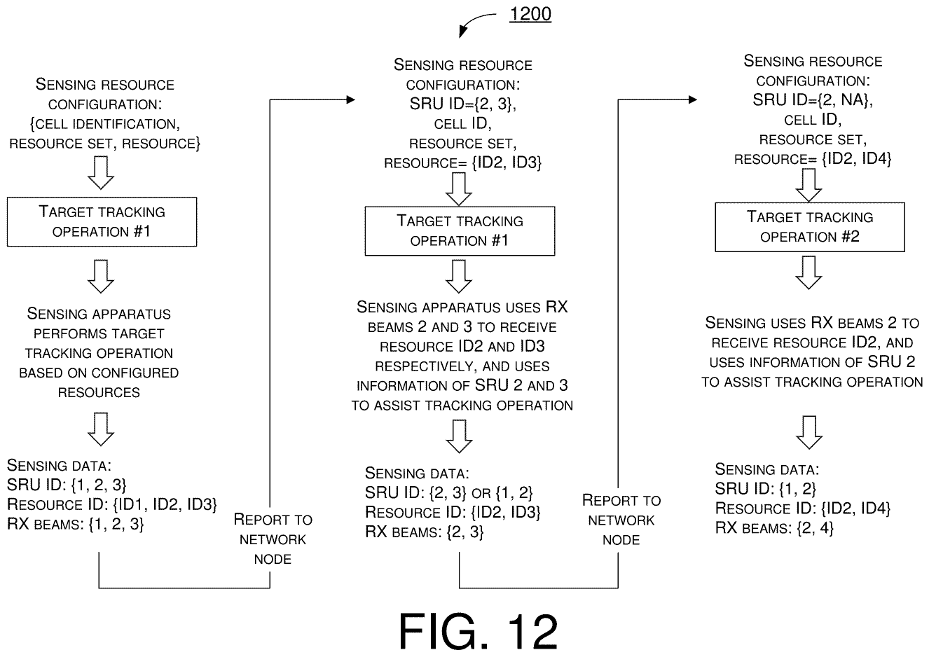

FIG. 12 illustrates an example scenario 1200 under schemes in accordance with implementations of the present disclosure. For example, there are two target tracking operations which are target tracking operation #1 and target tracking operation #2. During target tracking operation #1, the network node (having a sensing function) configures SRU identification and resource identification based on the sensing apparatus reporting in an earlier target detection stage. During target tracking operation #2, besides the sensing apparatus reported target (i.e., SRU identification=2), the network node (having sensing function) can configure a new target related resource to require the sensing apparatus to track. The sensing apparatus needs to perform different operations based on the configured SRU identification.

More specifically, corresponding to target tracking operation #1, the network node (having a sensing function) transmits the sensing resource configuration (including cell identification, resource set, and resource) to the sensing apparatus. The sensing apparatus performs a target detection (i.e., sensing) operation based on the configured resources. In this example, the sensing data includes: (1) SRU identification: {1, 2, 3}, (2) resource identification: {ID1, ID2, ID3}, and (3) sensing apparatus RX beams (locally stored): {1, 2, 3}. Then, the sensing apparatus reports the sensing data to the network node.

Based on the reported sensing data, the network node (having sensing function) transmits the sensing resource configuration to the sensing apparatus. The sensing resource configuration includes: (1) SRU identification: {2, 3}, (2) cell identification, (3) resource set, and (4) resource identification: {ID2, ID3}. The sensing apparatus uses RX beams 2 and 3 to receive the resource ID2 and ID3 respectively and uses information of SRU 2 and 3 to assist the tracking operation. The sensing data includes: (1) SRU identification: {2, 3}, or {1, 2} (map to new identification based on pre-defined rule), (2) resource identification: {ID2, ID3}, and (3) sensing apparatus RX beams (locally stored): {2, 3}. Then, the sensing apparatus reports the sensing data to the network node.

Corresponding to target tracking operation #2, based on the reported sensing data, the network node (having sensing function) transmits the sensing resource configuration to the sensing apparatus. The sensing resource configuration includes: (1) SRU identification: {2, NA}, (2) cell identification, (3) resource set, and (4) resource identification: {ID2, ID4}. The sensing apparatus uses RX beams 2 to receive the resource ID2 and uses information of SRU 2 to assist the tracking operation. There is no prior information available for processing resource ID4. The sensing data includes: (1) SRU identification {1, 2}, which may be implicitly indicated by the order of the reported SRUs, where ‘1’ corresponds to the configured SRU ID 2 and ‘2’ corresponds to the configured SRU ID NA, (2) resource identification: {ID2, ID4}, and (3) sensing apparatus RX beams (locally stored): {2, 4}.

In some embodiments, hybrid sensing signals may be introduced for various scenarios. In particular, a sensing task may be triggered by the network node (e.g., CN or RAN node) or the sensing apparatus. Based on the sensing task requirements, a hybrid sensing signal (e.g., a sensing signal including two types of sensing signals) may be used during one or more sensing stages.

It should be noted that, in some scenarios, the hybrid sensing signal may be required because: (1) different signals may be used for different sensing coverage, such as short- and long-distance sensing; and/or (2) different signals may be used for estimating different sensing dimensions or quantities, such as delay, Doppler, or angle.

In some cases, the hybrid sensing signal may include signal one (e.g., shared with communication reference signal (e.g., TRS, PRS)) and signal two (e.g., a dedicated sensing signal that uses dedicated time, frequency, or spatial resources and may employ an OFDM-based or non-OFDM-based waveform).

In some cases, the hybrid sensing signal may include signals one and two (e.g., both shared with communication reference (e.g., TRS, PRS, PTRS)).

In some cases, the hybrid sensing signal may include signals one and two (e.g., both signals are dedicated sensing signals, which may employ an OFDM-based or a non-OFDM-based waveform).

In some implementations, during a first stage, a first stage hybrid sensing signal may be configured and transmitted. The first stage hybrid sensing signal may include at least one of a first sensing signal and a second sensing signal. The sensing apparatus may receive the first stage hybrid sensing signal and determine a first stage sensing result based on the first stage hybrid sensing signal.

More specifically, the network node (having sensing function) may configure the first stage hybrid sensing signal to the sensing apparatus (e.g., sensing TX apparatus and sensing RX apparatus). The sensing TX apparatus may transmit the first stage hybrid sensing signal. The sensing RX apparatus may receive the first stage hybrid sensing signals and perform further signal processing to determine the first stage sensing result.

In some cases, the first stage hybrid sensing signal may be composed of two types of sensing signals (i.e., the first sensing signal and the second signal), and their corresponding configurations may be jointly determined based on the requirements of a sensing task. For example, a Pulse Waveform (PW) and a Continuous Waveform (CW) may be used to cover long-range and short-range sensing, respectively. For another example, a PRS-like reference signal and a PTRS-like reference signal may be used to support delay-domain estimation and Doppler-domain estimation, respectively.

In some cases, the purpose of the first stage may be target detection or coarse estimation. The first-stage hybrid sensing signal (including the two types of sensing signals) may be configured with a longer periodicity, a smaller BW, coarse beams or full-direction beams, and a sparse time and frequency domain pattern.

In some cases, the sensing data obtained from the two sensing signals may be integrated to form the first stage sensing result. For example, sensing operations are first performed separately for the two sensing signals, and the resulting sensing data is then integrated to obtain the final sensing result (i.e., the first stage sensing result). For another example, the two sensing signals are first combined into a single signal, and a sensing operation is then performed on the combined signal to produce the final sensing result (i.e., the first stage sensing result).

In some implementations, during a second stage, a second stage hybrid sensing signal may be determined based on the first stage sensing result. In particular, the sensing apparatus may transmit the first stage sensing result to the network node (having a sensing function). Then, the network node (having sensing function) may determine the second stage hybrid sensing signal based on the first stage sensing result.

Then, the second stage hybrid sensing signal may be configured and transmitted. The second stage hybrid sensing signal may include at least one of the first sensing signal and the second sensing signal. The sensing apparatus may receive the second stage hybrid sensing signal and determine a second stage sensing result based on the second stage hybrid sensing signal.

More specifically, when a target is detected, or a coarse estimation result is obtained in the first stage, the configuration of the second stage hybrid sensing signal may be determined based on some rules. For example, a PW is used for long-distance sensing, and a CW is used for short-distance sensing. When some targets are detected only at short distances, the configuration of the CW may be adjusted, or a new CW may be used for target tracking, while the PW configuration remains unchanged. When some targets are detected only at long distances, the configuration of the PW may be adjusted, or a new PW may be used for target tracking, while the CW configuration remains unchanged. When some targets are detected in both short and long distances, the configurations of both the PW and the CW are adjusted, or new PW and CW signals are used for target tracking.

For another example, a PRS-like reference signal is used for delay domain parameter estimation, while a PTRS-like reference signal is used for Doppler domain parameter estimation. When delay domain parameters require refinement, the configuration of the PRS-like reference signal is adjusted, or a new PRS-like reference signal is employed, while the configuration of the PTRS-like reference signal remains unchanged. When Doppler domain parameters require refinement, the configuration of the PTRS-like reference signal is adjusted, or a new PTRS-like reference signal is employed, while the configuration of the PRS-like reference signal remains unchanged. When both delay domain and Doppler domain parameters require refinement, the configurations of both reference signals are adjusted, or new PRS-like and PTRS-like reference signals are used.

In some cases, the configurations may include parameters such as Energy Per Resource Element (EPRE)/power, pattern, symbol number and symbol interval within a CPI, periodicity, subcarrier spacing (SCS), BW, and beam-related parameters (e.g., beam number, beam width, and beam direction), among others. The second-stage hybrid sensing signal may be more powerful than the first-stage hybrid sensing signal. For example, the second-stage signal may be configured with shorter periodicity, larger bandwidth, finer beams or beams directed toward specific directions, and a denser pattern in the time and frequency domains.

In some cases, the same sensing signals may be used in both the first stage and the second stage. In these cases, once the first stage is completed (e.g., when a target is detected), the sensing signals used in the first stage may no longer be employed. Instead, the determined second stage sensing signals may be used for both the first stage and the second stage during subsequent sensing periods.

In some implementations, more than one sensing signal may be configured for a single sensing task, and the results obtained from each signal may be integrated into a single report. For example, PW and CW signals, or PRS-like and PTRS-like signals, are configured to detect the same sensing area or to track the same sensing target. A common target identification is configured to indicate that the two signals correspond to the same sensing task. Reporting using the same task identification is then employed to integrate the results of the two signals into a single report.

In some implementations, the first results and the second results may be configured with the same sensing signal. The sensing apparatus may: (1) report the first stage sensing result and the second stage sensing result respectively, or (2) report an integrated report including the first stage sensing result and the second stage sensing result.

More specifically, the same sensing signal is used for both the first stage and the second stage. Reporting may include the results of two stages. A configuration may indicate that two reporting are configured with the same sensing signal. The first stage sensing result and the second stage sensing result may be reported respectively or reported as the integrated report.

In some implementations, the first results and the second results may be configured with different sensing signals. The sensing apparatus may: (1) report the first stage sensing result and the second stage sensing result respectively, or (2) report an integrated report including the first stage sensing result and the second stage sensing result.

More specifically, different sensing signals are used for the first stage and the second stage. One configuration may be configured with sensing signals in the first stage, and the other configuration may be configured with sensing signals in the second stage. The first stage sensing result and the second stage sensing result may be reported respectively or reported as the integrated report.

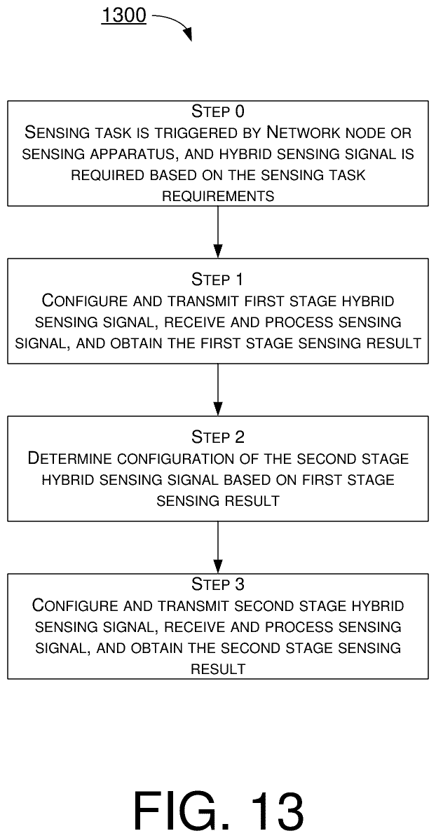

FIG. 13 illustrates an example scenario 1300 under schemes in accordance with implementations of the present disclosure. For example, there are four steps from step 0 to step 3. In step 0, the sensing task is triggered by the network node (CN or BS) or the sensing apparatus. A hybrid sensing signal is required based on the sensing task requirements. In other words, based on the sensing task requirements, the hybrid sensing signal (e.g., including two kinds of sensing signals) is used.

In step 1, the first stage hybrid sensing signal is configured and transmitted, the sensing signal is received and processed, and the first stage sensing result is obtained. In particular, the network node (having sensing function) configures the hybrid sensing signal to the sensing apparatus (including TX and RX). The sensing apparatus TX transmits the sensing signal, and the sensing apparatus RX receives the sensing signal and performs further signal processing. The hybrid sensing signal is composed of two kinds of sensing signals. The corresponding configurations are jointly determined based on the sensing task requirement. Since the purpose of the first stage is target detection or coarse estimation, the hybrid sensing signal (including two types of sensing signals) may be configured with a longer periodicity, a smaller bandwidth, coarse or full-direction beams, and a sparse pattern in the time and frequency domains. Two sensing data (calculated based on two types of sensing signals respectively) are integrated, and the first stage sensing result is obtained.

In step 2, the configuration of the second stage hybrid sensing signal is determined based on the first stage sensing result. In particular, when a target is detected or a coarse estimation result is obtained in the first stage, the configuration of the second stage sensing signal is determined. The configuration may primarily include parameters such as EPRE/power, pattern, the number of symbols and symbol intervals within a CPI, periodicity, SCS, bandwidth, and beam-related parameters (e.g., beam number, beam width, and beam direction), among others.

In step 3, the second stage hybrid sensing signal is configured and transmitted, the sensing signal is received and processed, and the second stage sensing result is obtained. In particular, the operations are similar to those in step 1. When the first stage and the second stage are based on the same sensing signals, the two stages may be performed simultaneously. Otherwise, the two stages may be performed separately based on their respective sensing signals.

In some embodiments, the sensing apparatus may receive an indication from the network node (having a sensing function). The indication may indicate the use of sensing signals to facilitate a communication operation. The sensing apparatus may perform the communication operation based on the indication.

More specifically, in the ISAC system, there may be dedicated sensing signals that may not be integrated with communication reference signals. The sensing signals may be for BS mono-static sensing, BS bi-static sensing, BS-UE bi-static DL sensing, UE-UE bi-static sensing, and/or UE mono-static sensing. When the sensing signals are transmitted, the sensing signals may be used to assist communication operations. In some cases, when the configuration of sensing signals is informed to the sensing apparatus, the sensing apparatus may perform some processing to reduce the impact on communication.

In some implementations, the sensing apparatus may utilize the sensing signals to replace communication signals. In particular, when a sensing task is enabled and sensing signals are transmitted, the sensing signals may replace certain communication reference signals (e.g., Synchronization Signal Block (SSB), Transmission Reception Point-Reference Signal (TRP-RS), Channel State Information-Reference Signal (CSI-RS) for beam management, TRS, PRS, etc.) to perform related communication operations, such as cell measurement, beam management, and timing and frequency synchronization.

In some implementations, the sensing apparatus may utilize a sensing result of the sensing signals to assist communication. In particular, when a sensing task is enabled and sensing signals are transmitted, some communication enhancement features may be enabled.

In some cases, Radio Resource Management (RRM) may be assisted by sensing. Based on sensing signals, a sensing module of the sensing apparatus may provide additional information to enhance RRM operations (e.g., as input to AI-based mobility). The sensing module may provide finer Doppler and delay estimation results between the sensing apparatus (e.g., a UE) and cells (e.g., serving and neighboring cells), which may help determine the movement direction of the sensing apparatus. The sensing module may also provide earlier and more accurate beam and synchronization information for neighboring cells, thereby reducing handover latency. In addition, the sensing module may provide extra channel information (e.g., multipath characteristics) to further assist RRM.

In some cases, Beam Management (BM) may be assisted by sensing. The sensing module of the sensing apparatus may determine the best Beam Pair Links (BPLs) based on beam sweeping performed using sensing signals. These best BPLs may assist communication-related BM operations and, for example, may replace the BM P1 procedure. In addition, the sensing signals may substitute for BM reference signals in performing BM procedures. Accordingly, when sensing signals are enabled, additional BM reference signals may not be required.

In some cases, synchronization may be assisted by sensing. The sensing module of the sensing apparatus may provide frequency and timing offset information, as well as channel characteristic in time domain and frequency domain, which may assist a synchronization module. In addition, sensing signals may substitute for synchronization reference signals. Accordingly, when sensing signals are enabled, additional synchronization reference signals may not be required.

In some implementations, Radio Link Monitoring (RLM), Beam Failure Recovery (BFR) and/or Beam Failure Detection (BFD) may be assisted by sensing. The sensing module of the sensing apparatus may provide channel quality information and beam quality information (e.g., Signal-to-Noise Ratio (SNR), SINR, Reference Signal Received Power (RSRP), etc.), which may help RLM, BFR, and/or BFD module(s). In addition, the sensing signals may replace reference signals for RLM, BFR, and/or BFD. Accordingly, when the sensing signals are enabled, the reference signals for RLM, BFR, and/or BFD may not be required.

In some implementations, the sensing apparatus may perform an operation for mitigating an impact on communication. In particular, when the sensing signals conflict with communication signals (e.g., reference signals, data), the sensing apparatus may skip the reception of the communication signal based on the configuration of the sensing signal.

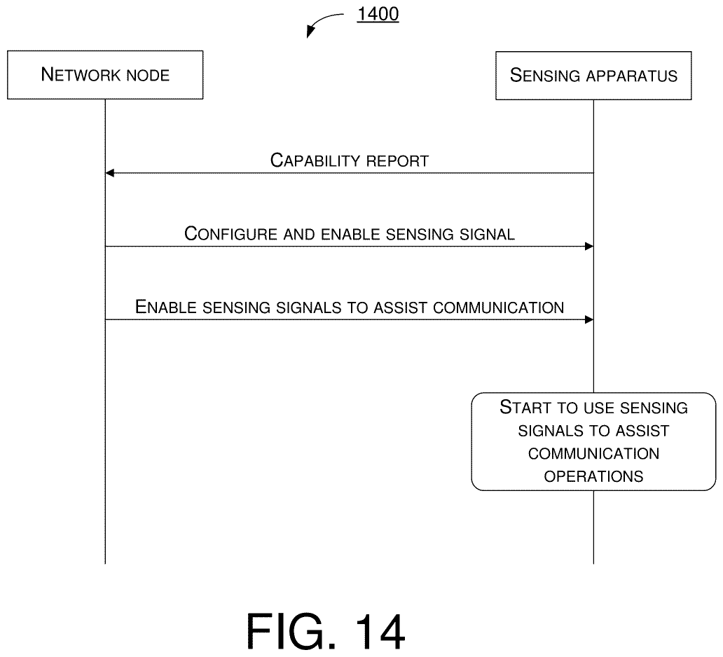

FIG. 14 illustrates an example scenario 1400 under schemes in accordance with implementations of the present disclosure. In some implementations, the sensing apparatus may transmit an apparatus capability of supporting the communication operation to the network node. More specifically, the sensing apparatus may report the capability of supporting the use of the sensing signal to assist communication or reduce the impact on communication.

Then, the network node may determine a configuration associated with the sensing signals and transmit the configuration to the sensing apparatus. In particular, the network node may inform the sensing apparatus of the configuration and validation of the sensing signal for both serving and neighbor cells through SIB, RRC, MAC-CE, DCI, paging, and/or PEI.

In some cases, the configuration may include an additional offset defined for use in cell reselection and handover criteria when both sensing signals and communication reference signals (e.g., SSB or TRS) are used. This may be because the serving cell and neighboring cells may employ different signals for cell measurement, and sensing signals and communication reference signals may have different power boosts.

In some cases, the configuration may include a defined quasi-co-location (QCL) relationship among communication data, sensing signals, and TRP-RS or SSB.

In some cases, the configuration may indicate that sensing signals may be treated as optional reference signals for BM, PRS, synchronization, RLM, BFD, and/or BFR. The network node may further indicate which signal is to be used for each of these operations.

Then, the network node may inform the sensing apparatus it may be able to use sensing signals to assist communication or reduce the impact on communication.

Next, when the sensing signals are enabled, the sensing apparatus may start to use the sensing signals to replace communication signals, use sensing results to assist communication operations, or perform specific operations to reduce the impact on communication.

In some cases, the sensing apparatus may receive the sensing signals to assist communication in idle, inactive, or connected mode. In some cases, the sensing apparatus may know the configuration of sensing signals to deal with the impact on communication in idle, inactive, or connected mode. In some cases, the sensing apparatus may receive or transmit a sensing signal for a DL or UL sensing task.

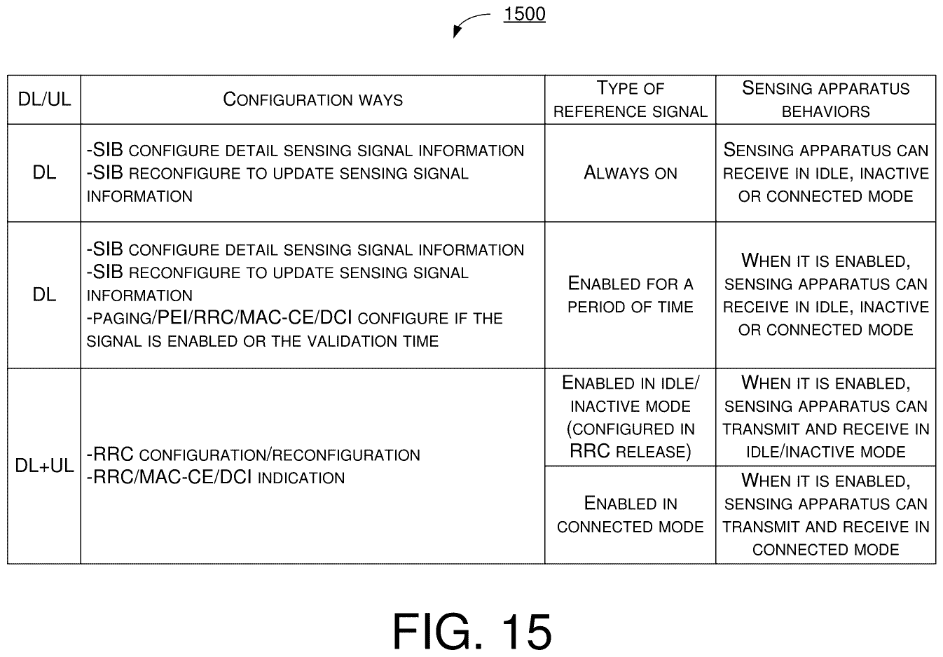

FIG. 15 illustrates an example scenario 1500 under schemes in accordance with implementations of the present disclosure. For example, the details of how the network node informs the sensing apparatus configuration and validation of the sensing signal through an SIB, an RRC, a MAC CE, a DCI, a paging, or a PEI are illustrated in the table. The configuration(s) is transceived by DL and/or UL message(s).

In one scenario using DL message, the configuration is provided through: (1) a SIB configuring the detailed sensing signal information, or (2) a SIB reconfiguring to update the sensing signal information. The type of reference signal is “Always On”. The sensing apparatus can receive the configuration in idle, inactive, or connected mode.

In one scenario using DL message, the configuration may be provided through: (1) a SIB configuring detail sensing signal information, (2) a SIB reconfiguring to update sensing signal information, or (3) paging, PEI, RRC, MAC CE, or DCI configuring the sensing signal when the signal is enabled or when a validation time is indicated. The type of reference signal is “Enabled for a period of time”. When being enabled, the sensing apparatus can receive the configuration in idle, inactive, or connected mode.

In one scenario using DL and UL messages, the configuration may be provided through: (1) an RCC configuration or RRC reconfiguration, or (2) RRC, MAC CE, or DCI indication. The type of reference signal is “Enabled in idle or inactive mode (configured in RRC release)” or “Enabled in connected mode”. When the type of reference signal is “Enabled in idle or inactive mode (configured in RRC release)”, the sensing apparatus can transmit and receive the configuration in idle or inactive mode. When the type of reference signal is “Enabled in connected mode”, the sensing apparatus can transmit and receive the configuration in connected mode.

### Illustrative Implementations

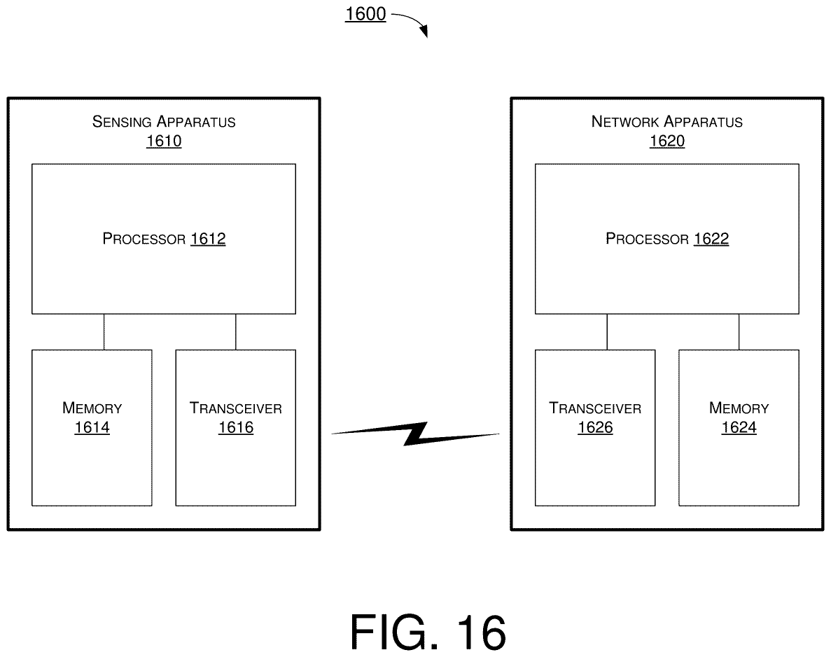

FIG. 16 illustrates an example ISAC system 1600 having an example sensing apparatus 1610 and an example network apparatus 1620 in accordance with an implementation of the present disclosure. Each of sensing apparatus 1610 and network apparatus 1620 may perform various functions to implement schemes, techniques, processes and methods described herein pertaining to ISAC operations with respect to UE and network apparatus in mobile communications, including scenarios/schemes described above as well as processes 1700, 1800, 1900, 2000 and 2100 described below.

Sensing apparatus 1610 may be: (1) a part of an electronic apparatus, which may be a UE such as a portable or mobile apparatus, a wearable apparatus, a wireless communication apparatus or a computing apparatus, or (2) a part of a network apparatus, which may be a network node such as a satellite, a base station, a small cell, a router or a gateway. For instance, sensing apparatus 1610 may be implemented in a smartphone, a smartwatch, a personal digital assistant, a digital camera, or a computing equipment such as a tablet computer, a laptop computer or a notebook computer. Sensing apparatus 1610 may also be a part of a machine type apparatus, which may be an IoT, NB-IoT, or IIoT apparatus such as an immobile or a stationary apparatus, a home apparatus, a wire communication apparatus or a computing apparatus. For instance, sensing apparatus 1610 may be implemented in a smart thermostat, a smart fridge, a smart door lock, a wireless speaker or a home control center. For instance, sensing apparatus 1610 may be implemented in an eNodeB in an LTE network, in a gNB in a 5G/NR, IoT, NB-IoT or IIoT network or in a satellite or base station in a 6G network. Alternatively, sensing apparatus 1610 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Sensing apparatus 1610 may include at least some of those components shown in FIG. 16 such as a processor 1612, for example. Sensing apparatus 1610 may further include one or more other components not pertinent to the proposed scheme of the present disclosure (e.g., internal power supply, display device and/or user interface device), and, thus, such component(s) of apparatus 1610 are neither shown in FIG. 16 nor described below in the interest of simplicity and brevity.

It should be noted that sensing apparatus 1610 may include a sensing TX and/or a sensing RX. For ease of illustration, only a single sensing apparatus 1610 is depicted in FIG. 16, and such depiction is not intended to limit the scope of the present disclosure. A person skilled in the art should readily understand that, in a bistatic sensing system, two sensing apparatuses 1610 may be employed, respectively functioning as a sensing TX and a sensing RX.

Network apparatus 1620 may be a part of a network apparatus, which may be a network node such as a satellite, a base station, a small cell, a router or a gateway. For instance, network apparatus 1620 may be implemented in an eNodeB in an LTE network, in a gNB in a 5G/NR, IoT, NB-IoT or IIoT network or in a satellite or base station in a 6G network. Alternatively, network apparatus 1620 may be implemented in the form of one or more IC chips such as, for example and without limitation, one or more single-core processors, one or more multi-core processors, or one or more RISC or CISC processors. Network apparatus 1620 may include at least some of those components shown in FIG. 16 such as a processor 1622, for example. Network apparatus 1620 may further include one or more other components not pertinent to the proposed scheme of the present disclosure (e.g., internal power supply, display device and/or user interface device), and, thus, such component(s) of network apparatus 1620 are neither shown in FIG. 16 nor described below in the interest of simplicity and brevity.

In one aspect, each of processor 1612 and processor 1622 may be implemented in the form of one or more single-core processors, one or more multi-core processors, or one or more CISC processors. That is, even though a singular term “a processor” is used herein to refer to processor 1612 and processor 1622, each of processor 1612 and processor 1622 may include multiple processors in some implementations and a single processor in other implementations in accordance with the present disclosure. In another aspect, each of processor 1612 and processor 1622 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1612 and processor 1622 is a special-purpose machine specifically designed, arranged and configured to perform specific tasks including ISAC operations in a device (e.g., as represented by communication apparatus 1610) and a network (e.g., as represented by network apparatus 1620) in accordance with various implementations of the present disclosure.

In some implementations, sensing apparatus 1610 may also include a transceiver 1616 coupled to processor 1612 and capable of wirelessly transmitting and receiving data. In other words, processor 1612 may transceive the data such as configuration, message, signal, information, indicator, etc. via transceiver 1616. In some implementations, sensing apparatus 1610 may further include a memory 1614 coupled to processor 1612 and capable of being accessed by processor 1612 and storing data therein. In some implementations, network apparatus 1620 may also include a transceiver 1626 coupled to processor 1622 and capable of wirelessly transmitting and receiving data. In other words, processor 1622 may transceive the data such as configuration, message, signal, information, indicator, etc. via transceiver 1626. In some implementations, network apparatus 1620 may further include a memory 1624 coupled to processor 1622 and capable of being accessed by processor 1622 and storing data therein. Accordingly, sensing apparatus 1610 and network apparatus 1620 may wirelessly communicate with each other via transceiver 1616 and transceiver 1626, respectively. To aid better understanding, the following description of the operations, functionalities and capabilities of each of sensing apparatus 1610 and network apparatus 1620 is provided in the context of a mobile communication environment in which sensing apparatus 1610 is implemented in or as a communication apparatus, a UE, or a network node (e.g., BS or CN), and network apparatus 1620 is implemented in or as a network node of a communication network.

In some implementations, each of memory 1614 and memory 1624 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1614 and memory 1624 may include a type of read-only memory (ROM) such as mask ROM, programmable ROM (PROM), erasable programmable ROM (EPROM) and/or electrically erasable programmable ROM (EEPROM). Alternatively, or additionally, each of memory 1614 and memory 1624 may include a type of non-volatile random-access memory (NVRAM) such as flash memory, solid-state memory, ferroelectric RAM (FeRAM), magnetoresistive RAM (MRAM) and/or phase-change memory.

### Illustrative Processes

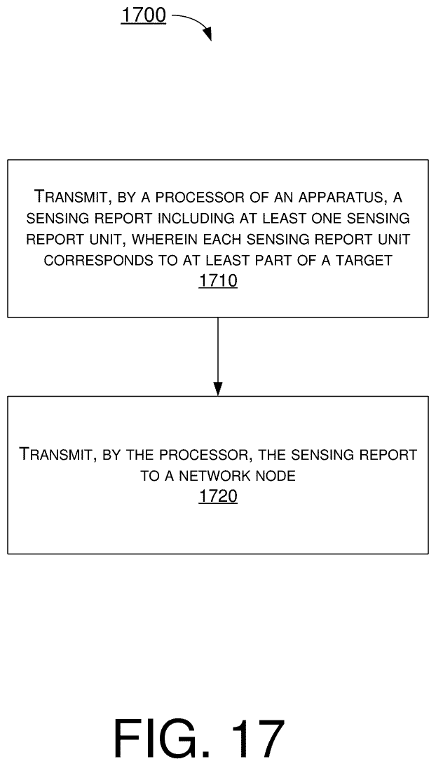

FIG. 17 illustrates an example process 1700 in accordance with an implementation of the present disclosure. Process 1700 may be an example implementation of above scenarios/schemes, whether partially or completely, with respect to ISAC operations of the present disclosure. Process 1700 may represent an aspect of implementation of features of sensing apparatus 1610. Process 1700 may include one or more operations, actions, or functions as illustrated by one or more of blocks 1710 and 1720. Although illustrated as discrete blocks, various blocks of process 1700 may be divided into additional blocks, combined into fewer blocks, or eliminated, depending on the desired implementation. Moreover, the blocks of process 1700 may be executed in the order shown in FIG. 17 or, alternatively, in a different order. Process 1700 may be implemented by sensing apparatus 1610 or any suitable UE, network devices or machine type devices. Solely for illustrative purposes and without limitation, process 1700 is described below in the context of sensing apparatus 1610. Process 1700 may begin at block 1710.

At block 1710, process 1700 may involve processor 1612 of sensing apparatus 1610 determining a sensing report including at least one sensing report unit. Each sensing report unit may correspond to at least part of a target. Process 1700 may proceed from block 1710 to block 1720.

At block 1720, process 1700 may involve processor 1612 of sensing apparatus 1610 transmitting the sensing report to a network node.

In some implementations, each sensing report unit may be associated with a size information of a grid and include at least one of: (1) a target identification, (2) a delay information, (3) a Doppler information, (4) an angle information, (5) a resource identification information, and (6) a power information.

In some implementations, the grid may include at least one granularity associated with at least one of a delay domain, a Doppler domain, and an angle domain.

In some implementations, the delay information may include at least one of: (1) a timing difference of arrival, (2) a receiving-transmitting timing difference, and (3) a timing of arrival.

In some implementations, the Doppler information may include at least one of: (1) a Doppler parameter, (2) a phase variation parameter, and (3) a speed parameter.

In some implementations, the angle information may include at least one of: (1) an Angle of Arrival (AoA), (2) a Zenith angle of Arrival (ZoA), (3) an Angle of Departure (AoD), (4) a Zenith angle of Departure (ZoD), and (5) a transmitting beam index.

In some implementations, the resource identification information may include at least one of: (1) a timestamp of resource, (2) a cell identification, and (3) a resource set and resource identification.

In some implementations, the power information may include at least one of: (1) an average power of the sensing report unit, (2) a size of the sensing report unit, (3) a total power of the sensing report unit, (4) an average power of interference and noise, and (5) a Signal to Interference and Noise Ratio (SINR).

In some implementations, the total power may be equal to the average power multiplied by the size of the sensing report unit. The average power of interference and noise may be equal to

$$P n / ( R t - R i ) \times Rg where$$

$$Pn = Pt - P 1 - P 2$$

where Rt may be an entire sensing range, Pt may be a total power of the entire sensing range, Ri may be a total range of detectable targets and other clutters, P1 may be a total power of the detectable targets, P2 may be a total power of the other clutters, and Rg may be a size of the grid.

In some implementations, each sensing report unit may be associated with absolute values, or relative values corresponding to a reference sensing report unit.

In some implementations, the network node may include at least one of a Radio Access Network (RAN) node having a sensing function and a Core Network (CN) having a sensing function.

In some implementations, in an event that the network node includes both the RAN node and the CN, the sensing report transmitted to the RAN may include: (1) a sensing report unit identification, (2) a resource identification information, and (3) a power information.

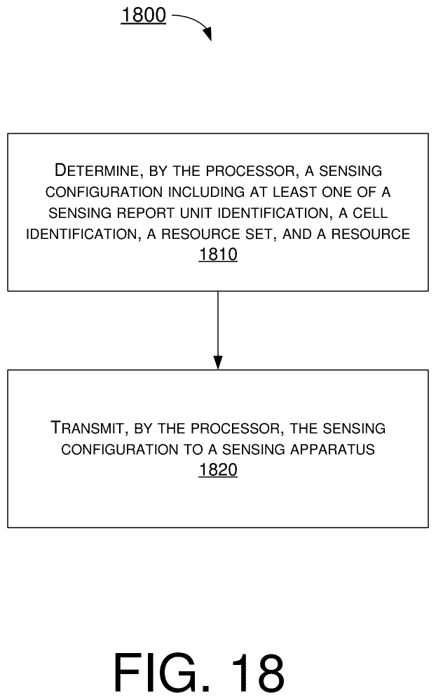

FIG. 18 illustrates an example process 1800 in accordance with an implementation of the present disclosure. Process 1800 may be an example implementation of above scenarios/schemes, whether partially or completely, with respect to ISAC operations of the present disclosure. Process 1800 may represent an aspect of implementation of features of network apparatus 1620. Process 1800 may include one or more operations, actions, or functions as illustrated by one or more of blocks 1810 and 1820. Although illustrated as discrete blocks, various blocks of process 1800 may be divided into additional blocks, combined into fewer blocks, or eliminated, depending on the desired implementation. Moreover, the blocks of process 1800 may be executed in the order shown in FIG. 18 or, alternatively, in a different order. Process 1800 may be implemented by network apparatus 1620 or any suitable network device or machine type devices. Solely for illustrative purposes and without limitation, process 1800 is described below in the context of network apparatus 1620. Process 1800 may begin at block 1810.

At block 1810, process 1800 may involve processor 1622 of network apparatus 1620 determining a sensing configuration including at least one of a sensing report unit identification, a cell identification, a resource set, and a resource. Process 1800 may proceed from block 1810 to block 1820.

At block 1820, process 1800 may involve processor 1622 of network apparatus 1620 transmitting the sensing configuration to a sensing apparatus.

In some implementations, process 1800 may further involve processor 1622 of network apparatus 1620 receiving a sensing report from the sensing apparatus. The sensing configuration may be determined based on the sensing report.

In some implementations, process 1800 may further involve processor 1622 of network apparatus 1620 transmitting the sensing configuration and validation information of sensing signal to the sensing apparatus via a control signaling.

In some implementations, the control signaling may include a System Information Block (SIB), a Radio Resource Control, a Media Access Control-Control Element (MAC-CE), Downlink Control Information (DCI), a paging, or a Paging Early Indication (PEI).

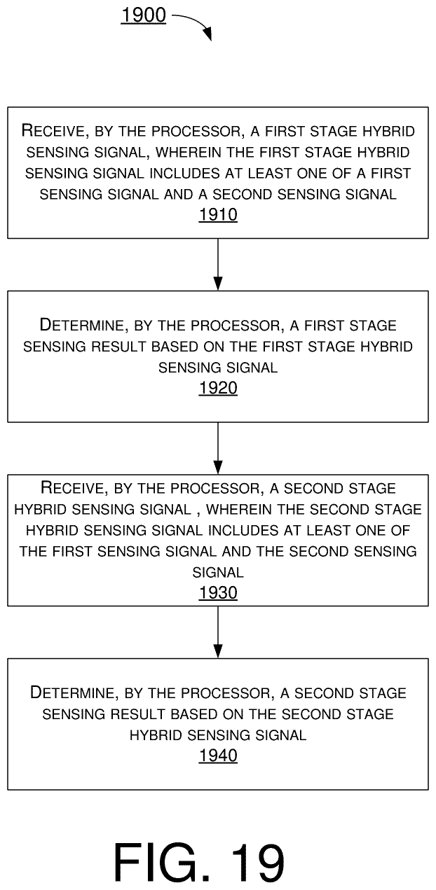

FIG. 19 illustrates an example process 1900 in accordance with an implementation of the present disclosure. Process 1900 may be an example implementation of above scenarios/schemes, whether partially or completely, with respect to ISAC operations of the present disclosure. Process 1900 may represent an aspect of implementation of features of sensing apparatus 1610. Process 1900 may include one or more operations, actions, or functions as illustrated by one or more of blocks 1910 to 1940. Although illustrated as discrete blocks, various blocks of process 1900 may be divided into additional blocks, combined into fewer blocks, or eliminated, depending on the desired implementation. Moreover, the blocks of process 1900 may be executed in the order shown in FIG. 19 or, alternatively, in a different order. Process 1900 may be implemented by sensing apparatus 1610 or any suitable UE, network devices or machine type devices. Solely for illustrative purposes and without limitation, process 1900 is described below in the context of sensing apparatus 1610. Process 1900 may begin at block 1910.

At block 1910, process 1900 may involve processor 1612 of sensing apparatus 1610 receiving a first stage hybrid sensing signal. The first stage hybrid sensing signal may include at least one of a first sensing signal and a second sensing signal. Process 1900 may proceed from block 1910 to block 1920.

At block 1920, process 1900 may involve processor 1612 of sensing apparatus 1610 determining a first stage sensing result based on the first stage hybrid sensing signal. Process 1900 may proceed from block 1920 to block 1930.

At block 1930, process 1900 may involve processor 1612 of sensing apparatus 1610 receiving a second stage hybrid sensing signal. The second stage hybrid sensing signal may include at least one of the first sensing signal and the second sensing signal. Process 1900 may proceed from block 1930 to block 1940.

At block 1940, process 1900 may involve processor 1612 of sensing apparatus 1610 determining a second stage sensing result based on the second stage hybrid sensing signal.

In some implementations, the second stage hybrid sensing signal may be determined based on the first stage sensing result.

In some implementations, the first results and the second result may be configured with the same sensing signal or different sensing signals. Process1900 may further involve processor 1612 of sensing apparatus 1610 reporting the first stage sensing result and the second stage sensing result respectively, or reporting an integrated report including the first stage sensing result and the second stage sensing result.

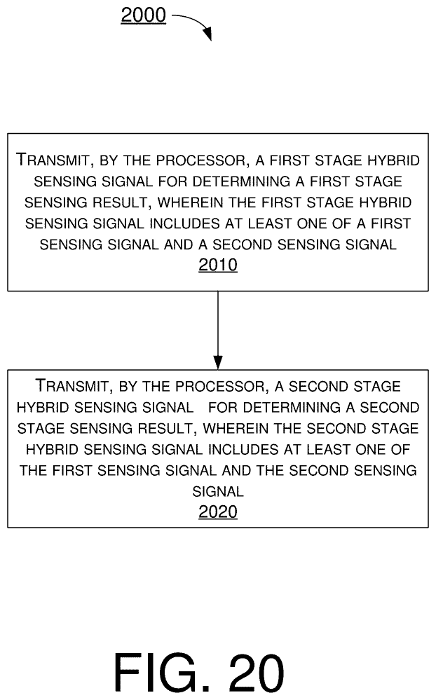

FIG. 20 illustrates an example process 2000 in accordance with an implementation of the present disclosure. Process 2000 may be an example implementation of above scenarios/schemes, whether partially or completely, with respect to ISAC operations of the present disclosure. Process 2000 may represent an aspect of implementation of features of sensing apparatus 1610. Process 2000 may include one or more operations, actions, or functions as illustrated by one or more of blocks 2010 and 2020. Although illustrated as discrete blocks, various blocks of process 2000 may be divided into additional blocks, combined into fewer blocks, or eliminated, depending on the desired implementation. Moreover, the blocks of process 2000 may be executed in the order shown in FIG. 20 or, alternatively, in a different order. Process 2000 may be implemented by sensing apparatus 1610 or any suitable UE, network devices or machine type devices. Solely for illustrative purposes and without limitation, process 2000 is described below in the context of sensing apparatus 1610. Process 2000 may begin at block 2010.

At block 2010, process 2000 may involve processor 1612 of sensing apparatus 1610 transmitting a first stage hybrid sensing signal for determining a first stage sensing result. The first stage hybrid sensing signal may include at least one of a first sensing signal and a second sensing signal. Process 2000 may proceed from block 2010 to block 2020.

At block 2020, process 2000 may involve processor 1612 of sensing apparatus 1610 transmitting a second stage hybrid sensing signal for determining a second stage sensing result. The second stage hybrid sensing signal may include at least one of the first sensing signal and the second sensing signal.

In some implementations, the second stage hybrid sensing signal may be determined based on the first stage sensing result.

In some implementations, the first results and the second result may be configured with the same sensing signal or different sensing signals. Process 2000 may involve processor 1612 of sensing apparatus 1610 receiving the first stage sensing result and the second stage sensing result respectively, or receiving an integrated report including the first stage sensing result and the second stage sensing result.

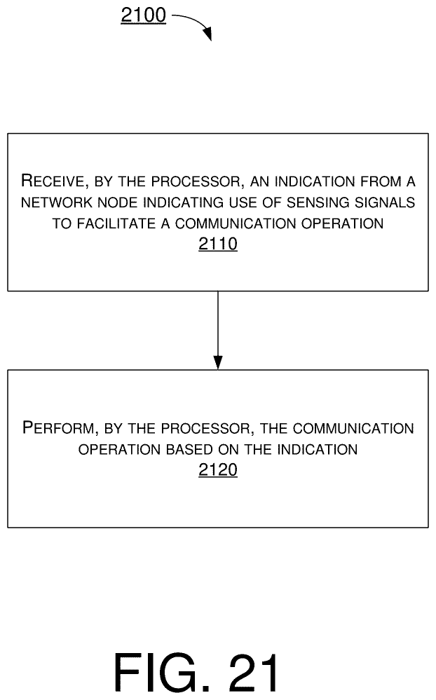

FIG. 21 illustrates an example process 2100 in accordance with an implementation of the present disclosure. Process 2100 may be an example implementation of above scenarios/schemes, whether partially or completely, with respect to ISAC operations of the present disclosure. Process 2100 may represent an aspect of implementation of features of sensing apparatus 1610. Process 2100 may include one or more operations, actions, or functions as illustrated by one or more of blocks 2110 and 2120. Although illustrated as discrete blocks, various blocks of process 2100 may be divided into additional blocks, combined into fewer blocks, or eliminated, depending on the desired implementation. Moreover, the blocks of process 2100 may be executed in the order shown in FIG. 21 or, alternatively, in a different order. Process 2100 may be implemented by sensing apparatus 1610 or any suitable UE, network devices or machine type devices. Solely for illustrative purposes and without limitation, process 2100 is described below in the context of sensing apparatus 1610. Process 2100 may begin at block 2110.

At block 2110, process 2100 may involve processor 1612 of sensing apparatus 1610 receiving an indication from a network node indicating use of sensing signals to facilitate a communication operation. Process 2100 may proceed from block 2110 to block 2120.

At block 2120, process 2100 may involve processor 1612 of sensing apparatus 1610 performing the communication operation based on the indication.

In some implementations, process 2100 may further involve processor 1612 of sensing apparatus 1610 utilizing the sensing signals to replace communication signals.

In some implementations, process 2100 may further involve processor 1612 of sensing apparatus 1610 utilizing a sensing result of the sensing signals to assist communication.

In some implementations, process 2100 may further involve processor 1612 of sensing apparatus 1610 performing an operation for mitigating an impact on communication.

In some implementations, process 2100 may further involve processor 1612 of sensing apparatus 1610 transmitting an apparatus capability of supporting the communication operation to the network node. Process 2100 may further involve processor 1612 of sensing apparatus 1610 receiving a configuration associated with the sensing signals from the network node.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of an apparatus, a sensing report including at least one sensing report unit, wherein each sensing report unit corresponds to at least part of a target; and
transmitting, by the processor, the sensing report to a network node.

2. The method of claim 1, wherein each sensing report unit is associated with a size information of a grid and includes at least one of:
a target identification,
a delay information,
a Doppler information,
an angle information,
a resource identification information, and
a power information.

3. The method of claim 2, wherein the grid includes at least one granularity associated with at least one of a delay domain, a Doppler domain, and an angle domain.

4. The method of claim 2, wherein the delay information includes at least one of:
a timing difference of arrival,
a receiving-transmitting timing difference, and
a timing of arrival.

5. The method of claim 2, wherein the Doppler information includes at least one of:
a Doppler parameter,
a phase variation parameter, and
a speed parameter.

6. The method of claim 2, wherein the angle information includes at least one of:
an Angle of Arrival (AoA),
a Zenith angle of Arrival (ZoA),
an Angle of Departure (AoD),
a Zenith angle of Departure (ZoD), and
a transmitting beam index.

7. The method of claim 2, wherein the resource identification information includes at least one of:
a timestamp of resource,
a cell identification, and
a resource set and resource identification.

8. The method of claim 2, wherein the power information includes at least one of:
an average power of the sensing report unit,
a size of the sensing report unit,
a total power of the sensing report unit,
an average power of interference and noise, and
a Signal to Interference and Noise Ratio (SINR).

9. The method of claim 8, wherein
the total power is equal to the average power multiplied by the size of the sensing report unit, and
the average power of interference and noise is equal to
$$P n / ( R t - R i ) \times Rg where$$
$$Pn = Pt - P 1 - P 2$$
where Rt is an entire sensing range, Pt is a total power of the entire sensing range, Ri is a total range of detectable targets and other clutters, P1 is a total power of the detectable targets, P2 is a total power of the other clutters, and Rg is a size of the grid.

10. The method of claim 1, wherein each sensing report unit is associated with:
absolute values, or
relative values corresponding to a reference sensing report unit.

11. The method of claim 1, wherein the network node includes at least one of a Radio Access Network (RAN) node having a sensing function and a Core Network (CN) having a sensing function.

12. The method of claim 11, wherein in an event that the network node includes both the RAN node and the CN, the sensing report transmitted to the RAN node includes:
a sensing report unit identification,
a resource identification information, and
a power information.

13. An apparatus, comprising:
a transceiver which, during operation, wirelessly communicates with a wireless network; and
a processor communicatively coupled to the transceiver such that, during operation, the processor performs operations comprising:
determining a sensing report including at least one sensing report unit, wherein each sensing report unit corresponds to at least part of a target; and
transmitting, via the transceiver, the sensing report to a network node.

14. A method, comprising:
determining, by a processor of an apparatus, a sensing configuration including at least one of a sensing report unit identification, a cell identification, a resource set, and a resource; and
transmitting, by the processor, the sensing configuration to a sensing apparatus.

15. The method of claim 14, further comprising:
receiving, by the processor, a sensing report from the sensing apparatus,
wherein the sensing configuration is determined based on the sensing report.

16. The method of claim 14, wherein the transmitting of the sensing configuration to the sensing apparatus further comprises:
transmitting, by the processor, the sensing configuration and validation information of sensing signal to the sensing apparatus via a control signaling.

17. The method of claim 16, wherein the control signaling includes a System Information Block (SIB), a Radio Resource Control, a Media Access Control-Control Element (MAC-CE), Downlink Control Information (DCI), a paging, or a Paging Early Indication (PEI).

18. A method, comprising:
receiving, by a processor of an apparatus, a first stage hybrid sensing signal, wherein the first stage hybrid sensing signal includes at least one of a first sensing signal and a second sensing signal;
determining, by the processor, a first stage sensing result based on the first stage hybrid sensing signal;
receiving, by the processor, a second stage hybrid sensing signal, wherein the second stage hybrid sensing signal includes at least one of the first sensing signal and the second sensing signal; and
determining, by the processor, a second stage sensing result based on the second stage hybrid sensing signal.

19. The method of claim 18, wherein the second stage hybrid sensing signal is determined based on the first stage sensing result.

20. The method of claim 18, wherein the first stage sensing result and the second stage sensing result are configured with the same sensing signal or different sensing signals, and the method further comprises:
reporting, by the processor, the first stage sensing result and the second stage sensing result respectively, or
reporting, by the processor, an integrated report including the first stage sensing result and the second stage sensing result.

21. An apparatus, comprising:
a transceiver which, during operation, wirelessly communicates with a wireless network; and
a processor communicatively coupled to the transceiver such that, during operation, the processor performs operations comprising:
receiving, via the transceiver, a first stage hybrid sensing signal, wherein the first stage hybrid sensing signal includes at least one of a first sensing signal and a second sensing signal;
determining a first stage sensing result based on the first stage hybrid sensing signal;
receiving, via the transceiver, a second stage hybrid sensing signal, wherein the second stage hybrid sensing signal includes at least one of the first sensing signal and the second sensing signal; and
determining a second stage sensing result based on the second stage hybrid sensing signal.

22. A method, comprising:
transmitting, by a processor of an apparatus, a first stage hybrid sensing signal for determining a first stage sensing result, wherein the first stage hybrid sensing signal includes at least one of a first sensing signal and a second sensing signal; and
transmitting, by the processor, a second stage hybrid sensing signal for determining a second stage sensing result, wherein the second stage hybrid sensing signal includes at least one of the first sensing signal and the second sensing signal.

23. The method of claim 22, wherein the second stage hybrid sensing signal is determined based on the first stage sensing result.

24. The method of claim 22, wherein the first stage sensing result and the second stage sensing result are configured with the same sensing signal or different sensing signals, and the method further comprises:
receiving, by the processor, the first stage sensing result and the second stage sensing result respectively, or
receiving, by the processor, an integrated report including the first stage sensing result and the second stage sensing result.

25. An apparatus, comprising:
a transceiver which, during operation, wirelessly communicates with a wireless network; and
a processor communicatively coupled to the transceiver such that, during operation, the processor performs operations comprising:
transmitting, via the transceiver, a first stage hybrid sensing signal for determining a first stage sensing result, wherein the first stage hybrid sensing signal includes at least one of a first sensing signal and a second sensing signal; and
transmitting, via the transceiver, a second stage hybrid sensing signal for determining a second stage sensing result, wherein the second stage hybrid sensing signal includes at least one of the first sensing signal and the second sensing signal.

26. A method, comprising:
receiving, by a processor of an apparatus, an indication from a network node indicating use of sensing signals to facilitate a communication operation; and
performing, by the processor, the communication operation based on the indication.

27. The method of claim 26, wherein the performing of the communication operation includes:
utilizing, by the processor, the sensing signals to replace communication signals.

28. The method of claim 26, wherein the performing of the communication operation includes:
performing, by the processor, an operation for mitigating an impact on communication.

29. The method of claim 26, further comprising:
transmitting, by the processor, an apparatus capability of supporting the communication operation to the network node; and
receiving, by the processor, a configuration associated with the sensing signals from the network node.

30. An apparatus, comprising:
a transceiver which, during operation, wirelessly communicates with a wireless network; and
a processor communicatively coupled to the transceiver such that, during operation, the processor performs operations comprising:
receiving, via the transceiver, an indication from a network node indicating use of sensing signals to facilitate a communication operation; and
performing the communication operation based on the indication.
